(19) United States
(12) Patent Application Publication
(10) Pub. No.: US 2025/0358531 A1
(43) Pub. Date: Nov. 20, 2025

(54) ELECTRONIC DEVICE FOR CONTROLLING CAMERA EXPOSURE, AND METHOD THEREFOR

(71) Applicant: SAMSUNG ELECTRONICS CO., LTD., Suwon-si (KR)

(72) Inventors: Bonghoon PARK, Suwon-si (KR); Jaeyun Jeong, Suwon-si (KR); Jiwon Jeong, Suwon-si (KR)

(73) Assignee: SAMSUNG ELECTRONICS CO., LTD., Suwon-si (KR)

(21) Appl. No.: 19/281,100

(22) Filed: Jul. 25, 2025

Related U.S. Application Data
(63) Continuation of application No. PCT/KR2023/020313, filed on Dec. 11, 2023.

(30) Foreign Application Priority Data
Jan. 26, 2023 (KR) 10-2023-0010236

(51) Int. Cl. H04N 23/73; G06T 7/246; H04N 23/71

(52) U.S. Cl. CPC H04N 23/73; G06T 7/248; H04N 23/71

(57) ABSTRACT

An electronic device, including: a first camera configured to capture a base image with respect to a space corresponding to the electronic device; a second camera configured to capture a line-of-sight image corresponding to a line-of-sight direction; a motion sensor; at least one processor; and a memory storing at least one instruction which, when executed by the at least one processor, causes the electronic device to: obtain light quantity information about a light quantity associated with the space, based on the base image; and determine, based on motion information obtained by the motion sensor and the light quantity information, an exposure value for capturing the line-of-sight image

### CROSS-REFERENCE TO RELATED APPLICATIONS

This application is a continuation of International Application No. PCT/KR2023/020313, filed on Dec. 11, 2023, in the Korean Intellectual Property Receiving Office, which is based on and claims priority to Korean Patent Application Number 10-2023-0010236, filed on Jan. 26, 2023, in the Korean Intellectual Property Office, the disclosures of which are incorporated by reference herein in their entireties.

### BACKGROUND

### 1. Field

The disclosure relates to an electronic device for controlling exposure of a camera and a method thereof. More particularly, the present disclosure relates to an electronic device for adjusting exposure of a regular camera according to a light quantity measured by using an image captured by a camera with a wide-angle view and a method thereof.

### 2. Description of Related Art

Augmented reality is a technique to overlay a virtual image on a physical environmental space of the real world or an object of the real world, thereby showing the virtual image and the physical environmental space or the object of the real world together. Augmented reality devices (for example, smart glasses) using the augmented reality technique are being usefully used in everyday life for information searching, directions, camera photography, etc. In particular, the smart glasses are also worn as fashion items and mainly used for outdoor activities.

The augmented reality devices may be categorized according to a structure of a display configured to output image information. In particular, a video see-through method is a method in which an image obtained through a camera and image information provided by a computer are synthesized and provided to a user. An augmented reality device using the video see-through method provides a camera for obtaining an image with respect to an actual ambient environment. However, after capturing an image with respect to a predetermined region of the actual ambient environment, an exposure value with respect to the corresponding region is adjusted, and thus, the camera using the video see-through method may have a temporal delay for controlling the exposure value, when an object region is rapidly changed.

### SUMMARY

In accordance with an aspect of the disclosure, an electronic device includes: a first camera configured to capture a base image with respect to a space corresponding to the electronic device; a second camera configured to capture a line-of-sight image corresponding to a line-of-sight direction; a motion sensor; at least one processor; and a memory storing at least one instruction which, when executed by the at least one processor, causes the electronic device to: obtain light quantity information about a light quantity associated with the space, based on the base image; and determine, based on motion information obtained by the motion sensor and the light quantity information, an exposure value for capturing the line-of-sight image.

In accordance with an aspect of the disclosure, a method executed by at least one processor included in an electronic device includes: obtaining light quantity information about a light quantity associated with a space corresponding to the electronic device, based on a base image with respect to the space; and based on the light quantity information and motion information obtained by a motion sensor included in the electronic device, determining an exposure value for capturing a line-of-sight image corresponding to a line-of-sight direction.

In accordance with an aspect of the disclosure, a computer-readable recording medium has recorded thereon at least one program which, when executed by at least one processor of an electronic device, causes the electronic device to: obtain light quantity information about a light quantity associated with a space corresponding to the electronic device, based on a base image with respect to the space; and based on the light quantity information and motion information obtained by a motion sensor included in the electronic device, determine an exposure value for capturing a line-of-sight image corresponding to a line-of-sight direction.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram for describing an operation of an electronic device according to an embodiment of the present disclosure;

FIG. 2 is a block diagram of components of an electronic device according to an embodiment of the present disclosure;

FIG. 3 is a conceptual diagram for describing in detail an operation of an electronic device according to an embodiment of the present disclosure;

FIG. 4 is a flowchart of an operating method of an electronic device, according to an embodiment of the present disclosure;

FIG. 5 is a flowchart of an operating method of an electronic device, according to an embodiment of the present disclosure;

FIG. 6 is a diagram for comparing a base image with a line-of-sight image captured by an electronic device according to an embodiment of the present disclosure;

FIG. 7 is a diagram for describing an operation, performed by an electronic device, of predicting a line-of-sight prediction direction of a user's view, according to an embodiment of the present disclosure;

FIG. 8 is a diagram for describing an operation, performed by an electronic device, of predicting a line-of-sight prediction direction of a user's view, according to an embodiment of the present disclosure;

FIG. 9 is a flowchart of an operating method, performed by an electronic device, of predicting a line-of-sight prediction direction of a user's view by using a position of a feature point, according to an embodiment of the present disclosure;

FIG. 10 is a diagram for describing a method, performed by an electronic device, of obtaining light quantity information with respect to a predicted direction, according to an embodiment of the present disclosure;

FIG. 11 is a flowchart of an operating method, performed by an electronic device, of obtaining light quantity information with respect to a predicted direction, according to an embodiment of the present disclosure;

FIG. 12 is a diagram for describing a method, performed by an electronic device, of determining an exposure value, according to an embodiment of the present disclosure; and

FIG. 13 is a flowchart of an operating method, performed by an electronic device, of determining an exposure value, according to an embodiment of the present disclosure.

### DETAILED DESCRIPTION

In the description below, general terms that have been widely used nowadays are selected, when possible, in consideration of functions of the present disclosure, but non-general terms may be selected according to the intentions of technicians in the this art, precedents, or new technologies, etc. Also, some terms may be arbitrarily chosen by the present applicant. In this case, the meanings of these terms will be explained in corresponding parts of an embodiment of the present disclosure in detail. Thus, the terms used herein should be defined not based on the names thereof but based on the meanings thereof and the whole context of the present disclosure.

A singular expression may include a plural expression, unless an apparently different meaning is indicated in the context. The terms used herein including technical or scientific ones may have meanings that are the same as the meanings generally understood by one of ordinary skill in the art described in this specification.

Throughout the present disclosure, when a part “includes” or “comprises” an element, the part may further include other elements, not excluding the other elements, unless there is a particular description contrary thereto. Also, the term, such as “unit” or “module,” used in the specification, refers to a unit that processes at least one function or operation, and this may be implemented by hardware, software, or a combination of hardware and software.

The expression “configured to (or set to)” used in the present disclosure may be interchangeably used according to situations, for example, with an expression, “suitable for,” “having the capacity to,” “designed to,” “adapted to,” “made to,” or “capable of.” The term “configured to (or set to)” may not necessarily denote only “specifically designed to” in terms of hardware. Instead, in certain situations, the expression “a system configured to” may denote that the system “has the capacity” to perform certain operations with other devices or components. For example, the phrase “a processor formed to (or configured to) perform A, B, and C” may denote a dedicated processor (for example, an embedded processor) for performing corresponding operations or a general-purpose processor (for example, a central processing unit (CPU) or an application processor) capable of performing the corresponding operations by executing one or more software programs stored in a memory.

Also, when it is described in the present disclosure that one element is “connected to” or “in connection with” another element, the element may be directly connected to or in connection with the other element, but it shall be also understood that the element may be connected to or in connection with the other element with yet another element present therebetween, unless particularly otherwise described.

As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

Hereinafter, an embodiment of the present disclosure will be described in detail with reference to the accompanying drawings, so that one of ordinary skill in the art may easily execute the embodiment of the present disclosure. However, the present disclosure may have different forms and should not be construed as being limited to the embodiment described herein.

In the present disclosure, an “electronic device” may indicate a head mounted display (HMD). However, the present disclosure is not limited thereto, and the “electronic device” may be realized as electronic devices of various shapes, such as a television (TV), a mobile device, a smartphone, a laptop computer, a desktop computer, a tablet personal computer (PC), an electronic book terminal, a digital broadcasting terminal, a personal digital assistant (PDA), a portable multimedia player (PMP), a wearable device, etc.

In the present disclosure, a “standard angle of view” may denote an angle of field that closely resembles human eyesight. According to an embodiment, the standard angle of view may also denote an angle of field section that closely resembles human eyesight. A “standard lens” may denote a lens having the standard angle of view as the angle of field. For example, a standard lens may have a focal distance of 50 mm and an angle of view of 47 degrees.

Hereinafter, embodiments of the present disclosure are described in detail with reference to the drawings.

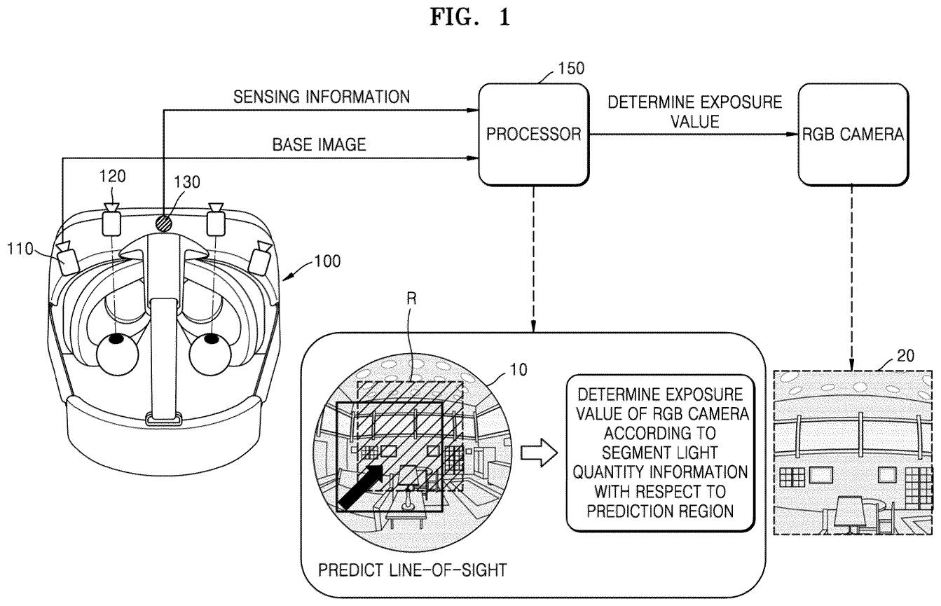

FIG. 1 is a conceptual diagram for describing an operation of an electronic device according to an embodiment of the present disclosure.

Referring to FIG. 1, an electronic device 100 may include augmented reality glasses of a glasses-type worn on a facial portion of a user. The electronic device 100 may predict a line-of-sight direction of a user by using pieces of information obtained by a first camera 110 (e.g., first cameras 110L and 110R) and a motion sensor 130 and may predetermine an exposure value of a second camera 120 (e.g., second cameras 120L and 120R) for performing photographing with respect to the predicted direction.

By predetermining the exposure value of the second camera 120, the electronic device 100 may obtain an image of the second camera 120, captured based on an appropriate exposure value, even when a line-of-sight direction instantly changes. The electronic device 100 may provide, to a user, an image having an appropriate brightness, even when the line-of-sight direction suddenly changes.

However, the electronic device 100 according to the present disclosure is not limited to the augmented reality glasses and may include an augmented reality device, such as an HMD apparatus or an augmented reality helmet worn on a head part of a user. However, the electronic device 100 according to the present disclosure is not limited to the augmented reality device. According to another embodiment of the present disclosure, the electronic device 100 may be realized as various types of electronic devices, such as a mobile device, a smartphone, a laptop computer, a tablet PC, an electronic book terminal, a digital broadcasting terminal, a PDA, a PMP, a navigation device, an MP3 player, a camcorder, an Internet protocol television (IPTV), a digital television (DTV), a wearable device, etc.

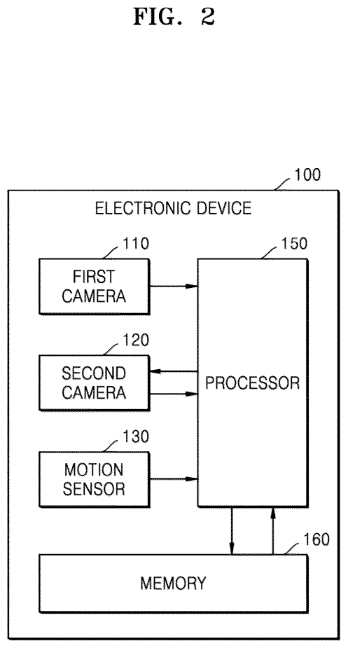

According to an embodiment, the electronic device 100 may include the first camera 110, the second camera 120, the motion sensor 130, and a processor 150 (examples of which are described with reference to FIG. 2).

According to an embodiment, the first camera 110 may obtain a base image 10. The base image 10 may be an image captured with respect to a space surrounding a user. The base image may be an image captured with respect to the space surrounding the user by using a wide angle. An angle of view of the first camera 110 configured to capture the base image may be greater than an angle of view of a regular camera. For example, a region of the base image 10 may include a greater area than a region of a line-of-sight image 20 captured by the second camera 120.

According to an embodiment, the base image 10 may include light quantity information with respect to an object space. The electronic device 100 may obtain light quantity information with respect to a light quantity of the space surrounding the user, based on the base image 10. For example, the electronic device 100 may measure an intensity of light with respect to the space surrounding the user, based on the base image 10.

According to an embodiment, the base image 10 may be an image sequence sequentially obtained during a predetermined time period. The electronic device 100 may measure an intensity of light with respect to an increased region, based on the base image 10 sequentially obtained.

Also, according to an embodiment, the base image 10 may include a plurality of images captured in various directions. The electronic device 100 may obtain light quantity information with respect to a light quantity of the entire space surrounding the user, based on the plurality of base images 10. The electronic device 100 may measure an intensity of light with respect to the entire space surrounding the user, based on the base image 10.

According to an embodiment, the electronic device 100 may obtain a base map, based on the base image 10, and store the base map in a memory 160. In some embodiments, the electronic device 100 may obtain a pre-obtained base map from the memory 160 and measure the intensity of light with respect to the space surrounding the user, based on the obtained base map.

According to an embodiment, the motion sensor 130 may obtain motion information. The electronic device 100 may obtain motion information with respect to a motion of the electronic device 100 from the motion sensor 130. For example, the motion information may include information about at least one of acceleration and angular velocity of the electronic device 100. The motion information may, however, further include information about velocity or displacement calculated through acceleration, and may further include information about an earth's magnetic field (e.g., a geomagnetic field).

The motion sensor 130 may include, for example, an inertial measurement unit (IMU).

According to an embodiment, the electronic device 100 may predict a line-of-sight direction of a user's view, based on the base image and the motion information.

The electronic device 100 may determine a motion of a user wearing the electronic device 100, based on the base image and the motion information. For example, the electronic device 100 may obtain, based on the motion information about the motion of the electronic device, information about a direction of a movement of the user wearing the electronic device, rotation of the head of the user, etc. The electronic device 100 may obtain, based on the motion information and the base image, information about in which space a user is located, and obtain, based on sensing information, information about which motion the user is performing.

For example, the motion information may indicate information including at least one of position, velocity, acceleration, and angular velocity. However, it is only an example, and the motion information may include less or more information than the described information, respectively, in order to increase the processing speed of a processor and in order to obtain a precise output value of the processor. For example, the motion information may include information about angular acceleration.

For example, the electronic device 100 may obtain the motion information by using a simultaneous localization and mapping (SLAM) technique. The electronic device 100 may generate a map of a space surrounding the electronic device 100 by receiving the base image 10 and the motion information obtained through the motion sensor. Simultaneously, the electronic device 100 may determine a position and a movement of the user on the generated map.

According to an embodiment, the electronic device 100 may obtain, based on the base image, feature point position information with respect to movement of one or more feature points within the base image. The electronic device 100 may determine the motion information based on a relative motion indicated by the feature point position information (e.g., a relative motion of the electronic device 100 with respect to the one or more feature points, or a relative motion of the one or more feature points with respect to the electronic device 100).

For example, the electronic device 100 may obtain, as feature points, a position of a certain halted object, a predetermined part, a predetermined region, etc., included in the base image. The electronic device 100 may obtain the feature point position information about a position and movement of the feature point in the sequential base images. The electronic device 100 may obtain, based on the feature point position information, motion information about a user's movement and direction moving relatively with respect to the feature point.

According to an embodiment, the electronic device 100 may predict a line-of-sight prediction direction of a user's view, based on the motion information. The electronic device 100 may predict the line-of-sight prediction direction of a future user's view, based on the base image and the motion information at the point of capturing the base image.

For example, the electronic device 100 may obtain the motion information by using the SLAM technique and predict the line-of-sight prediction direction of the user's view. The electronic device 100 may receive the base image and the motion information obtained through the motion sensor so as to generate the map of the space surrounding the electronic device 100 and determine the position and the movement of the user on the map. The electronic device 100 may predict the line-of-sight prediction direction of the user's view by taking into account the tendency of the movement of the user.

The electronic device 100 may set, within the base image 10, a prediction region R in the line-of-sight prediction direction. The prediction region R may correspond to an image region to be captured by the second camera 120. According to an embodiment, the electronic device 100 may extract segment light quantity information with respect to the prediction region, from the light quantity information obtained from the base image 10.

According to an embodiment, the electronic device 100 may determine an exposure value of the second camera 120, according to the segment light quantity information. For example, the electronic device 100 may determine, by using the segment light quantity information with respect to the prediction region R in the base image 10, the exposure value, based on which the second camera 120 may photograph the prediction region R,

The electronic device 100 may obtain the line-of-sight image 20 by photographing the prediction region R by using the second camera 120 based on the determined exposure value. The line-of-sight image 20 may indicate an image captured by an appropriate brightness based on the predetermined exposure value. The electronic device 100 may predict the line-of-sight direction of the user and predetermine the exposure value and may thus obtain the line-of-sight image 20 having an appropriate brightness even when the line-of-sight of the user rapidly changes.

According to an embodiment, the electronic device 100 may obtain the motion information about a movement and a direction of the electronic device by using the SLAM technique. The electronic device 100 may obtain, as input data, the base image 10 and the motion information obtained through the motion sensor by using the SLAM technique, may obtain the map of the space surrounding the electronic device 100, and may determine a position and a movement of the electronic device on the map. The electronic device 100 may obtain information about a position and a movement of the user, based on the position and the movement of the electronic device.

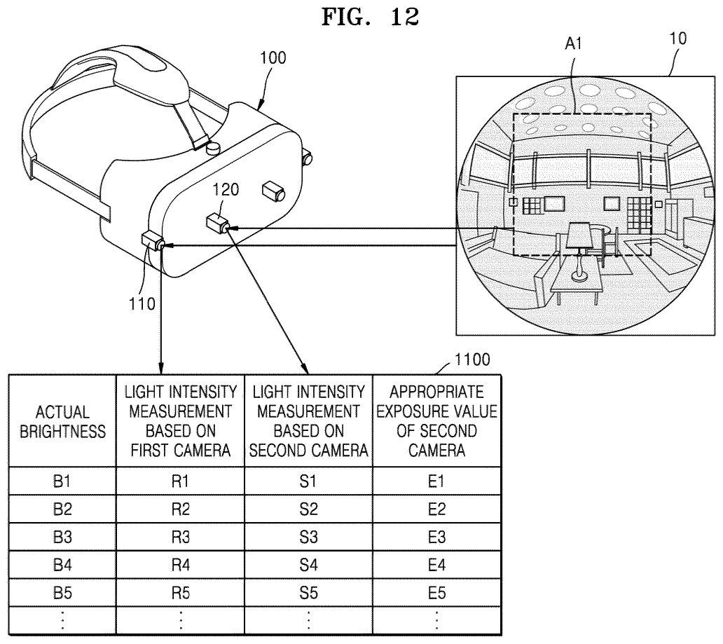

For example, the electronic device 100 may obtain the base image 10 with respect to a direction in the map of the space, toward which the user is positioned at a first time point, and a position and a line-of-sight direction of the user at the first time point, and may predict a line-of-sight direction of the user at a second time point. The electronic device 100 may set, within the base image 10, a region including the predicted line-of-sight direction of the user, and extract segment light quantity information with respect to the set region. The electronic device 100 may determine, based on the segment light quantity information, an exposure value, based on which the second camera 120 may photograph the region including the predicted line-of-sight direction of the user. The electronic device 100 may determine the exposure value by using a light quantity matching list, which is to be described in detail below with reference to FIG. 12.

FIG. 2 is a block diagram of components of an electronic device according to an embodiment of the present disclosure.

Referring to FIG. 2, the electronic device 100 may include the first camera 110, the second camera 120, the motion sensor 130, the processor 150, and the memory 160. FIG. 2 illustrates only essential components for describing an operation of the electronic device 100, and the components included in the electronic device 100 are not limited to the components illustrated in FIG. 2. According to an embodiment of the present disclosure, the electronic device 100 may further include a display, a microphone, etc.

The first camera 110 may be configured to capture a base image with respect to a space surrounding a user. The first camera 110 may obtain the base image with respect to a space in front of the user. The base image obtained through the first camera 110 may be captured by using a wide angle. An angle of view of the first camera 110 may be greater than an angle of view of a regular camera. For example, the angle of view of the first camera 110 may be greater than an angle of view of the second camera 120. The base image may include a larger region than a line-of-sight image captured by the second camera 120.

The second camera 120 may capture the line-of-sight image based on a line-of-sight of the user. The second camera 120 may obtain the line-of-sight image by photographing a region in accordance with a line-of-sight direction of the user in the space surrounding the user. The line-of-sight image obtained through the second camera 120 may be captured by a standard angle of view.

The motion sensor 130 may obtain motion information about a motion of the electronic device 100. The motion information may include information about at least one of acceleration and angular velocity of the electronic device 100.

The processor 150 may execute one or more instructions of a program stored in the memory 160. The processor 150 may include hardware components for performing arithmetic, logic, and input and output operations and image processing. FIG. 2 illustrates the processor 150 as one element, but it is not limited thereto. According to an embodiment of the present disclosure, the processor 150 may include one or more elements. The processor 150 may include a general-purpose processor, such as a CPU, an application processor (AP), a digital signal processor (DSP), etc., a graphics-dedicated processor, such as a graphics processing unit (GPU) or a vision processing unit (VPU), or an artificial intelligence-dedicated processor, such as a neural processing unit (NPU).

According to an embodiment, the processor 150 may obtain the base image by using the first camera 110. The base image may indicate an image with respect to the space surrounding the user. The base image may include information about the brightness of the space surrounding the user. The processor 150 may obtain light quantity information about a light quantity of the space surrounding the user, based on the base image.

According to an embodiment, the processor 150 may obtain the base image, which is an image sequence sequentially obtained through the first camera 110 during a predetermined time period. The processor 150 may obtain a base map by combining the sequentially obtained base images. The base map may indicate information with respect to the entire space surrounding the user. The processor 150 may store the base map in the memory 160.

When the base map with respect to the space surrounding the user is previously stored in the memory 160, the processor 150 may obtain the base map from the memory 160. The processor 150 may obtain the light quantity information about the light quantity of the space surrounding the user, based on the base map.

According to an embodiment, the processor 150 may predict a line-of-sight prediction direction of a user's view, based on the base image and the motion information.

For example, the processor 150 may obtain the base image captured at a first time point by using the first camera 110 and the motion information obtained at the first time point by using the motion sensor 130. The processor 150 may obtain information about a motion of the user with respect to the first time point, based on the base image and the motion information. The processor 150 may predict a line-of-sight prediction direction of a user's view at a second time point, by taking into account the motion of the user at the first time point. The second time point may be a time point after the first time point.

According to an embodiment, the processor 150 may extract segment light quantity information with respect to a prediction region in the line-of-sight prediction direction, from light quantity information. The prediction region may correspond to an image region, which may be photographed by the second camera 120.

According to an embodiment, the processor 150 may obtain a plurality of base images captured through the first camera 110 at various time points with respect to the same prediction region. The processor 150 may obtain a first base image and a second base image commonly including the prediction region. The processor 150 may obtain first segment light quantity information based on the first base image and second segment light quantity information based on the second base image. The processor 150 may obtain average segment light quantity information based on the first segment light quantity information and the second segment light quantity information.

According to an embodiment, the processor 150 may determine, based on the segment light quantity information, an exposure value to capture a line-of-sight image with respect to the line-of-sight prediction direction by using the second camera. For example, the processor 150 may determine the exposure value for obtaining the line-of-sight image by using the second camera 120, according to the segment light quantity information obtained based on the base image captured by the first camera 110.

According to an embodiment, the processor 150 may obtain a light quantity matching list in which a light quantity measured by using the first camera 110 and a light quantity measured by using the second camera 120 are matched with respect to the same brightness. According to an embodiment, the light quantity matching list may be stored in the memory 160, and the processor 150 may obtain the pre-stored light quantity matching list from the memory 160.

According to an embodiment, the processor 150 may apply the segment light quantity information to the light quantity matching list in order to obtain corresponding light intensity measurement information with respect to a light quantity to be measured based on the second camera 120 according to the segment light quantity information. For example, the processor 150 may obtain, based on the segment light quantity information obtained by measuring the intensity of light based on the first camera 110, the corresponding light intensity measurement information to be measured based on the second camera 120. The processor 150 may determine the exposure value based on the corresponding light intensity measurement information.

According to an embodiment, the processor 150 may obtain the line-of-sight image, based on the determined exposure value, by using the second camera 120.

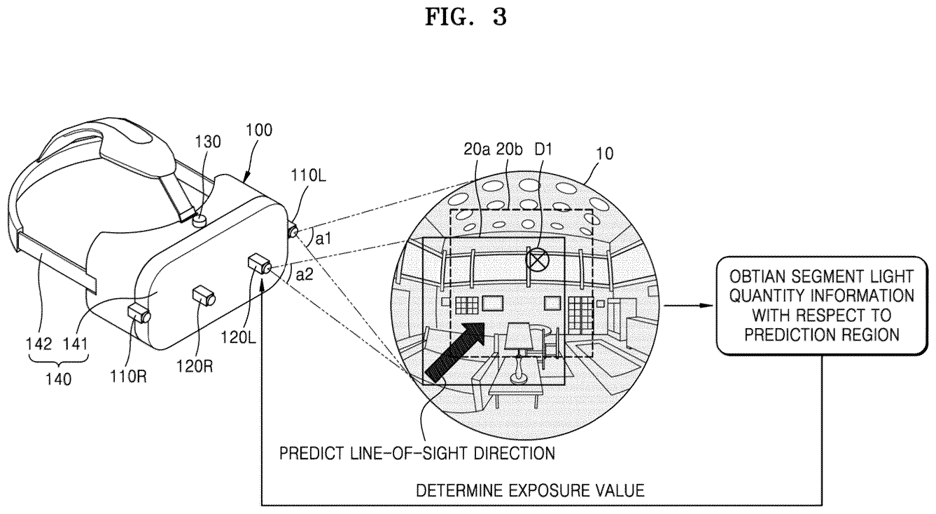

FIG. 3 is a conceptual diagram for describing an operation of an electronic device according to an embodiment of the present disclosure.

For convenience of explanation, the same aspects as described with reference to FIGS. 1 and 2 are briefly described or are not described.

Referring to FIG. 3, the electronic device 100 may include a housing 140 forming the exterior of the electronic device 100, and the components of the electronic device 100 may be mounted in the housing 140 or mounted in the housing 140 to be exposed to the outside.

The housing 140 may include a cover frame 141 covering a right eye and a left eye and a support frame 142 for supporting the electronic device 100 on the head of a user. FIG. 3 illustrates the cover frame 141 as a single component configured to cover both the right eye and the left eye. However, the cover frame 141 may include a left-eye cover frame covering the left eye and a right-eye cover frame covering the right eye.

The electronic device 100 may include a display, the first cameras 110L and 110R, the second cameras 120L and 120R, and the motion sensor 130.

According to an embodiment, the display may be arranged on an inner surface of the cover frame 141. The display may be arranged on the inner surface of the cover frame 141, and thus, although it is not illustrated, according to an embodiment, the user may view, by wearing the electronic device 100, a line-of-sight image obtained based on an exposure value predicted through the display arranged on the inner surface of the cover frame 141. The electronic device 100 may output an image through the display arranged on the inner surface of the cover frame 141, so that the user may view the image.

According to an embodiment, the electronic device 100 may obtain the base image 10 with respect to a space surrounding the user, by using the first cameras 110L and 110R.

The first cameras 110L and 110R may include cameras with a wide-angle view for obtaining wide-angle images. The first cameras 110L and 110R may include cameras including wide-angle lenses. The first cameras 110L and 110R may include cameras having an angle of view greater than an angle of field of human eyes.

However, the angle of view of the first cameras 110L and 110R does not limit the technical concept of the present disclosure. For example, an angle of view a1 of the first camera may be greater than an angle of view a2 of the second camera. For example, the first cameras 110L and 110R may have a relatively greater angle of view than the second cameras 120L and 120R.

According to an embodiment, the first cameras 110L and 110R may be arranged on side surfaces of the cover frame 141. For example, the first camera 110L at a left side may be arranged on a left side surface of the cover frame 141, and the first camera 110R at a right side may be arranged on a right side surface of the cover frame 141.

The first cameras 110L and 110R may have an angle of view encompassing a region in a line-of-sight direction toward which a user's line-of-sight is arranged. For example, the first camera 110L at the left side may have an angle of view toward the left side of the user from the line-of-sight direction. The first camera 110L at the left side may have an angle of view including a line-of-sight direction of the left eye. The first camera 110R at the right side may have an angle of view toward the right side of the user from the line-of-sight direction. The first camera 110R at the right side may have an angle of view including a line-of-sight direction of the right eye.

According to an embodiment, the electronic device 100 may obtain the base image by using each of the first camera 110L at the left side and the first camera 110R at the right side. For example, as illustrated, the electronic device 100 may obtain the base image 10 by using the first camera 110L at the left side. Although not shown, the electronic device 100 may also obtain another base image by using the first camera 110R at the right side.

FIG. 3 illustrates that the electronic device 100 may include the first cameras 110L and 110R arranged on the both side surfaces of the cover frame 141. However, the number of first cameras 110 and the positions of the first cameras do not limit the technical concept of the present disclosure. For example, the electronic device 100 may include four first cameras. As another example, the electronic device 100 may include first cameras arranged on upper, lower, right, and left side surfaces of the cover frame 141.

According to an embodiment, the electronic device 100 may obtain the line-of-sight image with respect to the space surrounding the user by using the second cameras 120L and 120R.

According to the present disclosure, for convenience of explanation of FIG. 3, the line-of-sight image illustrated in FIG. 3 may include a first line-of-sight image captured by the second cameras 120L and 120R with respect to a first line-of-sight region 20a and a second line-of-sight image captured by the second cameras 120L and 120R with respect to a second line-of-sight region 20b.

According to the present disclosure, a line-of-sight region may denote a region included in the line-of-sight image. In comparison with this, a prediction region may denote a line-of-sight region including a line-of-sight prediction direction predicted by the electronic device from among various line-of-sight regions.

The second cameras 120L and 120R may include standard cameras for obtaining an image having a standard angle of view. The second cameras 120L and 120R may indicate cameras including standard lenses. The second cameras 120L and 120R may include cameras having an angle of view similar to an angle of field of human eyes. The second cameras 120L and 120R may include, for example, cameras which may capture an image by converting an optical signal input through a lens into an electrical signal corresponding to a red-green-blue (RGB) image, and may for example be referred to as RGB cameras.

According to an embodiment, the second cameras 120L and 120R may be arranged on a front surface of the cover frame 141. For example, the second camera 120L at a left side may be arranged on the front surface on the cover frame 141 in a direction of the view of a line-of-sight of the left eye of the user. The second camera 120R at the right side may be arranged on the front surface on the cover frame 141 in a direction of the view of a line-of-sight of the right eye of the user.

The second cameras 120L and 120R may have an angle of view encompassing a direction of the view of a line-of-sight of the user. For example, the second camera 120L at the left side may have an angle of view with the direction of the view of the line-of-sight of the left eye of the user as the center thereof. The second camera 120R at the right side may have an angle of view with the direction of the view of the line-of-sight of the right eye of the user as the center thereof.

According to an embodiment, the electronic device 100 may obtain the line-of-sight image according to the line-of-sight of the user by using the second cameras 120L and 120R. The electronic device 100 may obtain the line-of-sight image with respect to the first and second line-of-sight regions 20a and 20b. The line-of-sight image may include an image output by a standard angle of view with respect to the space surrounding the user. The line-of-sight image may include an image output by a standard angle of view with respect to a region in front of the user in the space surrounding the user. The line-of-sight image may include an image output by a standard angle of view with respect to a region in the direction of the view of the line-of-sight of the user.

According to an embodiment, the electronic device 100 may obtain the line-of-sight image by using each of the second camera 120L at the left side and the second camera 120R at the right side. For example, as illustrated, the electronic device 100 may obtain the first line-of-sight image with respect to the first line-of-sight region 20a by using the second camera 120L at the left side. Also, although not shown, the electronic device 100 may obtain the second line-of-sight image with respect to the second line-of-sight region 20b by using the second camera 120R at the right side.

The electronic device 100 may capture an image of the region in the direction of the view of the line-of-sight of the user by using the second cameras 120L and 120R and may display the captured image through a display. The electronic device 100 may provide the image to the user by an angle of view closely resembling human eyesight.

According to an embodiment, the electronic device 100 may obtain motion information by using the motion sensor 130. The motion information may include information with respect to a motion of the electronic device 100. For example, the motion information may include information about at least one of acceleration and angular velocity of the electronic device 100. The motion information may include information about velocity or displacement calculated through acceleration.

According to an embodiment, the electronic device 100 may predict a line-of-sight prediction direction D1 of a user's view, based on motion information with respect to a motion of the user.

The electronic device 100 may obtain information with respect to the motion of the user in the space surrounding the user, based on the base image 10 and the motion information. The electronic device 100 may predict the line-of-sight prediction direction D1 by taking into account the motion of the user.

For example, the electronic device 100 may obtain the base image 10 by using the first cameras 110L and 110R, and simultaneously, may obtain the motion information by using the motion sensor 130. The electronic device 100 may obtain information about a moving speed of the user, based on the base image 10 and the motion information. When the moving speed of the user is constant, the electronic device 100 may predict a position and the line-of-sight direction of the user after a certain time period, based on the constant moving speed.

As another example, the electronic device 100 may obtain information about movement of the line-of-sight of the user, based on the base image 10 and the motion information. For example, the electronic device 100 may obtain information about a rotation speed of the head of the user. When the rotation speed of the head of the user is constant, the electronic device 100 may predict the line-of-sight direction of the user after a certain time period, based on the constant rotation speed.

According to an embodiment, the electronic device 100 may set the second line-of-sight region 20b in the line-of-sight prediction direction D1 as a prediction region. The base image 10 may include light quantity information about a light quantity of the space surrounding the user. The electronic device 100 may extract, from the base image 10, segment light quantity information with respect to the second line-of-sight region 20b set as the prediction region.

The light quantity information and the segment light quantity information may denote a light quantity, brightness, or illuminance with respect to a predetermined region. For example, the light quantity information may denote a light quantity received by a unit area during a unit time period.

According to an embodiment, the electronic device 100 may determine an exposure value of the second cameras 120L and 120R according to the segment light quantity information. The electronic device 100 may obtain the line-of-sight image by photographing the second line-of-sight region 20b, which is set as the prediction region, by using the second cameras 120L and 120R, based on the determined exposure value.

According to an embodiment, the exposure value E may be calculated through Equation 1.

$$E = I \cdot T \qquad [ Equation 1 ]$$

Here, E may indicate the exposure value, I may indicate a luminous intensity, and T may indicate an exposure time.

I may indicate the luminous intensity of light received by an image sensor in a camera through a camera lens. I may be adjusted according to an effective aperture of the camera lens. For example, the effective aperture of the camera lens may be controlled by adjusting an aperture of the camera, and I may be adjusted according to the effective aperture of the camera lens.

T may indicate a time period during which the light may be received by the image sensor in the camera through the camera lens. T may indicate a time period during which a shutter of the camera is open. By adjusting the time period during which the shutter of the camera is open, the quantity of light arriving at the image sensor may be adjusted, and consequently, the brightness of a picture may be adjusted.

According to an embodiment, E may be calculated by multiplying I by T. According to the present disclosure, the exposure value may indicate a concept including the luminous intensity (I) and the time (T).

According to an embodiment, the electronic device 100 may determine the exposure value E based on the segment light quantity information with respect to the line-of-sight prediction direction D1, which is obtained from the base image 10. The segment light quantity information with respect to the line-of-sight prediction direction D1 may indicate light quantity information with respect to the prediction region encompassing the line-of-sight prediction direction D1. The determined exposure value E may denote an appropriate exposure value for photographing the prediction region by using the second cameras 120L and 120R by taking into account the brightness of the prediction region. For example, the determined exposure value E may denote an appropriate exposure value for photographing the second line-of-sight region 20b set as the prediction region by using the second cameras 120L and 120R.

According to an embodiment, the electronic device 100 may determine the luminous intensity 1, based on the determined exposure value. For example, when a shutter speed of the second cameras 120L and 120R is fixed, the electronic device 100 may determine an appropriate luminous intensity for obtaining the determined exposure value.

According to an embodiment, the electronic device 100 may determine the time T, based on the determined exposure value. For example, when the effective aperture of the camera lens of the second cameras 120L and 120R is fixed, the electronic device 100 may determine an appropriate time for obtaining the determined exposure value. For example, the electronic device 100 may determine an appropriate shutter speed.

According to an embodiment, the electronic device 100 may obtain the line-of-sight image by using the second cameras 120L and 120R, based on the determined exposure value. For example, the electronic device 100 may obtain the second line-of-sight image with respect to the second line-of-sight region 20b, based on the exposure value determined by predicting the line-of-sight prediction direction D1. The first line-of-sight image may also be obtained according to the exposure value determined based on the line-of-sight prediction direction previously predicted.

For example, the electronic device 100 may determine, based on the determined exposure value, the luminous intensity for photographing the second line-of-sight region 20b set as the prediction region, by using the second cameras 120L and 120R. The electronic device 100 may control light corresponding to the determined luminous intensity to be received through the image sensor, by adjusting the effective aperture of the camera lens through the aperture of the camera. The electronic device 100 may obtain the second line-of-sight image with respect to the second line-of-sight region 20b, by processing data obtained by using the image sensor.

As another example, the electronic device 100 may determine, based on the determined exposure value, the time period for photographing the prediction region through the second cameras 120L and 120R (e.g., the shutter speed of the second cameras 120L and 120R). The electronic device 100 may control the amount of time during which the shutter is open (e.g., the shutter speed) according to the required exposure, so that the light quantity corresponding to the determined exposure value may be received through the image sensor. The electronic device 100 may obtain the second line-of-sight image with respect to the second line-of-sight region 20b, by processing data obtained by using the image sensor.

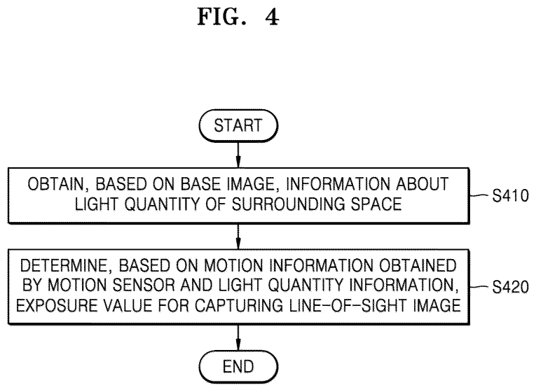

FIG. 4 is a flowchart of an operating method of an electronic device, according to an embodiment of the present disclosure.

For convenience of explanation, the same aspects as described with reference to FIGS. 1 to 3 are briefly described or are not described.

Referring to FIG. 4, in operation S410, the electronic device may obtain information about a light quantity of a surrounding space, based on a base image.

According to an embodiment, the electronic device may obtain the base image with respect to the space surrounding the user by using a first camera. The electronic device may include the first camera arranged toward the space surrounding the user. According to an embodiment, the first camera may include a camera including a wide-angle lens. The base image obtained by the first camera may include a wide-angle image.

According to an embodiment, the electronic device may obtain light quantity information with respect to a light quantity of the space, based on the base image. The light quantity information may denote a light quantity, brightness, or illuminance included in the base image.

In operation S420, the electronic device may determine an exposure value for capturing a line-of-sight image, based on motion information obtained by a motion sensor and the light quantity information.

According to an embodiment, the electronic device may obtain the motion information by using the motion sensor. The motion information may include information about at least one of acceleration and angular velocity of the electronic device. The motion information may further include information about velocity or displacement calculated through acceleration and may further include information about a magnetic field.

The electronic device may obtain information about a motion of the user wearing the electronic device, based on the motion information with respect to the electronic device. For example, the electronic device may obtain information about a movement direction and speed of the user, a speed of rotation of the head of the user, etc., based on the motion information.

According to an embodiment, the electronic device may predict a line-of-sight direction of the user, based on the motion information. The electronic device may extract light quantity information with respect to the predicted line-of-sight direction, from the obtained light quantity information. The electronic device may determine the exposure value according to the extracted partial light quantity information. The electronic device may determine the exposure value for capturing a line-of-sight image with respect to the predicted line-of-sight direction through a second camera.

According to an embodiment, the electronic device may obtain the line-of-sight image by performing photographing, based on the determined exposure value, with respect to the predicted line-of-sight direction.

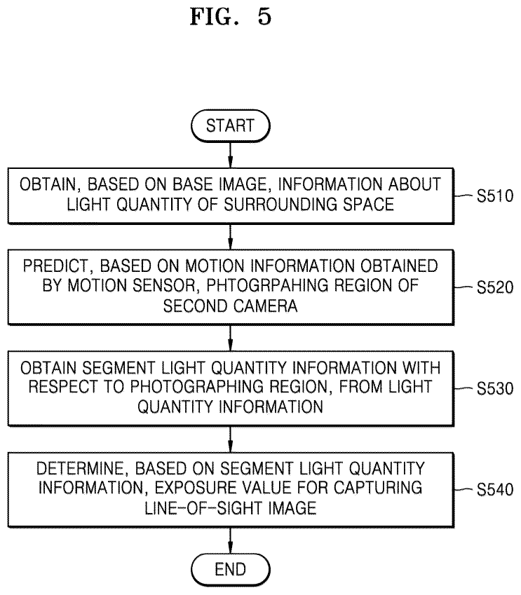

FIG. 5 is a flowchart of an operating method of an electronic device, according to an embodiment of the present disclosure.

For convenience of explanation, the same aspects as described with reference to FIG. 4 are briefly described or are not described.

Referring to FIG. 5, in operation S510, the electronic device may obtain information about a light quantity of a surrounding space, based on a base image. Operation S510 may be the same as or similar to operation S410 of FIG. 4, and therefore redundant or duplicative description thereof may be omitted.

In operation S520, the electronic device predict a photographing region of a second camera, based on motion information obtained by a motion sensor.

According to the present disclosure, the photographing region may denote a region to be photographed by the second camera and may denote the same as a line-of-sight region indicating a region included in a line-of-sight image.

According to an embodiment, the electronic device may further obtain the motion information by using the motion sensor. The motion information may include information about at least one of acceleration and angular velocity of the electronic device. The electronic device may obtain information about a motion of a user in a space surrounding the user, based on the base image and the motion information.

For example, the electronic device may obtain information about at least one of a movement speed, a movement direction, and a rotation speed of the user, based on the motion information.

According to an embodiment, the electronic device may obtain the motion information by determining a relative motion of the electronic device by using a feature point included in the base image. For example, the base image may include an image sequence sequentially captured during a predetermined time period. The electronic device may determine that a position of the electronic device is shifted toward the right side, as the feature point included in the base image is shifted toward the left side. As another example, the electronic device may determine that a direction of the electronic device is rotated, as the feature point included in the base image is shifted toward the left side.

According to an embodiment, the electronic device may obtain the base image captured at a first time point and the motion information obtained at the first time point. The electronic device may determine a motion of the user corresponding to the first time point, based on the base image and the motion information. The electronic device may predict a line-of-sight prediction direction of a user's view at a second time point, based on the motion of the user at the first time point. The second time point may be a time point after the first time point.

For example, the electronic device may obtain, based on the base image and the motion information, information that the user moves by a constant speed toward a predetermined direction at the first time point. The electronic device may determine, based on the constant speed of the user, the line-of-sight prediction direction of the user's view at a user's position at the second time point.

As another example, the electronic device may obtain, based on the base image and the motion information, information that the user constantly rotates toward a predetermined direction at the first time point. The electronic device may determine, based on the constant rotation speed, the line-of-sight prediction direction of the user's view at the second time point.

The electronic device may predict the photographing region of the second camera, based on the determined line-of-sight prediction direction.

In operation S530, the electronic device may extract segment light quantity information with respect to a photographing region in a line-of-sight prediction direction, from light quantity information.

According to an embodiment, the electronic device may determine the photographing region in the line-of-sight prediction direction, based on the base image. The photographing region may correspond to an image region which may be photographed by the second camera.

According to an embodiment, the electronic device may extract the segment light quantity information with respect to the photographing region, from the light quantity information. The base image may include the light quantity information. The electronic device may obtain, based on the image, the segment light quantity information with respect to a light quantity of the photographing region. The segment light quantity information may be data obtained by measuring the intensity of light with respect to a first camera.

In operation S540, the electronic device may determine, based on the segment light quantity information, an exposure value for capturing a line-of-sight image with respect to the line-of-sight prediction direction by using the second camera.

According to an embodiment, the electronic device may determine, based on the segment light quantity information with respect to the predicted photographing region, the exposure value of the second camera for photographing the predicted photographing region. The exposure value may be calculated based on a luminous intensity and an exposure time with respect to light.

For example, the electronic device may determine the exposure value of the second camera with respect to the predicted photographing region. The electronic device may determine, based on the determined exposure value, an exposure time with respect to light, when a luminous intensity is fixed (for example, when an effective aperture of a camera lens is fixed by using an aperture). For example, the electronic device may control the exposure time by adjusting a time period during which a shutter is open. The electronic device may photograph the predicted photographing region by using the second camera, according to the determined exposure time with respect to the light.

As another example, the electronic device may determine the exposure value of the second camera with respect to the predicted photographing region. The electronic device may determine, based on the determined exposure value, a luminous intensity, when an exposure time with respect to light is fixed (for example, when a shutter speed is fixed). For example, the electronic device may control the luminous intensity by adjusting the aperture of the camera. The electronic device may photograph the predicted photographing region by using the second camera, according to the determined luminous intensity.

According to an embodiment, the electronic may obtain, based on the determined exposure value, the line-of-sight image by using the second camera. The electronic device may obtain a vivid image with respect to the prediction region, by adjusting exposure of the second camera based on the determined exposure value.

For example, the electronic device may determine an exposure time with respect to light, based on the determined exposure value. The electronic device may obtain the line-of-sight image obtained by vividly photographing the prediction region, by adjusting a shutter speed of the second camera according to the determined exposure time with respect to the light.

As another example, the electronic device may determine a luminous intensity based on the determined exposure value. The electronic device may obtain the line-of-sight image obtained by vividly photographing the prediction region, by adjusting an aperture of the second camera according to the determined luminous intensity.

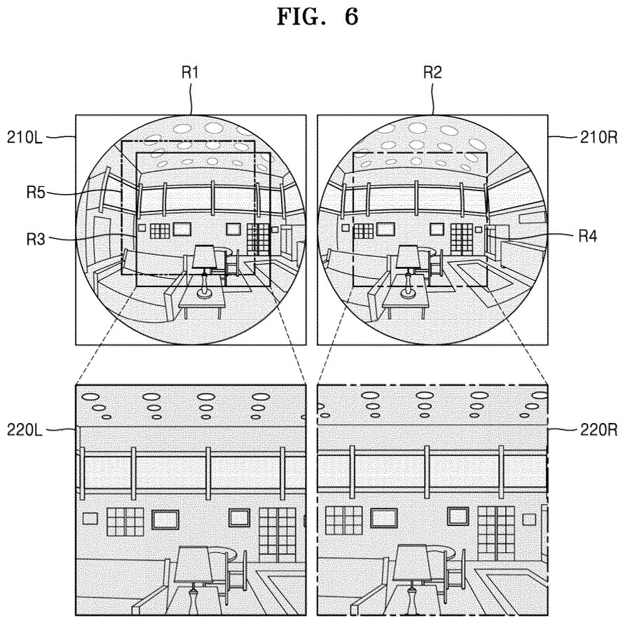

FIG. 6 is a diagram for comparing images captured by using a first camera and a second camera of an electronic device according to an embodiment of the present disclosure.

For reference, a left eye line-of-sight image 220L may indicate an image with respect to a left eye line-of-sight region R3, and a right eye line-of-sight image 220R may indicate an image with respect to a right eye line-of-sight region R4.

Referring to FIG. 6, according to an embodiment, the electronic device may obtain base images 210L and 210R by using the first camera. The electronic device may include a plurality of first cameras and may obtain the base images 210L and 210R by using the plurality of first cameras, respectively.

As illustrated, the electronic device may obtain the base image 210L at the left side by using the first camera at the left side. The electronic device may obtain the base image 210R at the right side by using the first camera at the right side. However, the technical concept of the present disclosure does not limit the number of first cameras, and further more base images may be obtained according to the number of first cameras.

According to an embodiment, the base images 210L and 210R may be captured by the first cameras including wide-angle lenses. The base images 210L and 210R may include wide-angle images. The base images 210L and 210R may include images indicating base regions R1 and R2 having wide angles.

According to an embodiment, the base image 210L at the left side may be captured by the first camera at the left side, and thus, may correspond to an image with respect to a left side front space of a user. The base image 210L at the left side may correspond to an image with respect to the base region R1 at the left side. The base image 210R at the right side may be captured by the first camera at the right side, and thus, may correspond to an image with respect to a right side front space of the user. The base image 210R at the right side may correspond to an image with respect to the base region R2 at the right side.

Based on the base image 210L at the left side and the base image 210R at the right side, the electronic device 100 may obtain data with respect to a further increased region. For example, the electronic device 100 may obtain light quantity information with respect to the increased region, based on the base image 210L at the left side and the base image 210R at the right side.

According to an embodiment, the electronic device may obtain the left eye and right eye line-of-sight images 220L and 220R by using the second camera. The electronic device may include a plurality of second cameras, which may obtain the left eye and right eye line-of-sight images 220L and 220R, respectively.

As illustrated, the electronic device may obtain the left eye line-of-sight image 220L by using the second camera at the left side. The electronic device may obtain the right eye line-of-sight image 220R by using the second camera at the right side.

According to an embodiment, the left eye and right eye line-of-sight images 220L and 220R may be captured by the second cameras including standard lenses. The left eye and right eye line-of-sight images 220L and 220R may include images having a standard angle of view. The left eye and right eye line-of-sight images 220L and 220R may include images having an angle of view similar to an angle of field of human eyes. The left eye and right eye line-of-sight images 220L and 220R may include images indicating the line-of-sight regions R3 and R4 having an angle of view similar to the angle of field of the human eyes.

According to an embodiment, the left eye line-of-sight image 220L may be captured by the second camera at the left side, which is arranged in a line-of-sight direction of the left eye of the user, and thus, may correspond to an image with respect to the front space of the user in the line-of-sight direction of the left eye of the user. The left eye line-of-sight image 220L may correspond to an image with respect to the left eye line-of-sight region R3. According to an embodiment, the right eye line-of-sight image 220R may be captured by the second camera at the right side, which is arranged in a line-of-sight direction of the right eye of the user, and thus, may correspond to an image with respect to the front space of the user in the line-of-sight direction of the right eye of the user. The right eye line-of-sight image 220R may correspond to an image with respect to the right eye line-of-sight region R4. Based on the left eye line-of-sight image 220L and the right eye line-of-sight image 220R, the electronic device may provide the user with an image which is felt like as if the user directly views the image.

According to an embodiment, the base regions may include the line-of-sight regions. For example, the base region photographed by the first camera may include the line-of-sight region photographed by the second camera corresponding to the first camera.

For example, the base image 210L at the left side may indicate an image with respect to the base region R1 at the left side which is photographed by the first camera at the left side. The left eye line-of-sight image 220L may indicate an image with respect to the left eye line-of-sight region R3 which is photographed by the second camera of the left eye. In conclusion, the base region R1 at the left side may include the left eye line-of-sight region R3.

As another example, the base image 210R at the right side may indicate an image with respect to the base region R2 at the right side which is photographed by the first camera at the right side. The right eye line-of-sight image 220R may indicate an image with respect to the right eye line-of-sight region R4 which is photographed by the second camera of the right eye. In conclusion, the base region R2 at the right side may include the right eye line-of-sight region R4.

Thus, the electronic device according to an embodiment may use the base images 210L and 210R for obtaining information with respect to the outside of the line-of-sight region. For example, the electronic device may pre-obtain light quantity information with respect to the outside of the line-of-sight regions R3 and R4 by using the base images 210L and 210R. For example, the electronic device may pre-obtain the light quantity information with respect to a prediction region R5 outside the line-of-sight region R3 by using the base image 210L. The electronic device may predetermine an exposure value of the second camera for photographing the prediction region R5 by predicting a movement of the line-of-sight of the user.

According to an embodiment, the electronic device may set the prediction region R5 by predicting a line-of-sight prediction direction. The prediction region R5 may be one of various predicted line-of-sight regions. Like the line-of-sight regions R3 and R4, the prediction region R5 may be included in the base regions R1 and R2. The electronic device may pre-obtain segment light quantity information with respect to the prediction region R5 by using the base images 210L and 210R and may predetermine the exposure value of the second camera for photographing the prediction region R5.

FIG. 6 illustrates that the prediction region R5 may be set on the base image 210L at the left side by predicting a motion of the line-of-sight of the left eye. However, it is only an example, and the prediction region may be set on the base image 210R at the right side by predicting a motion of the line-of-sight of the right eye.

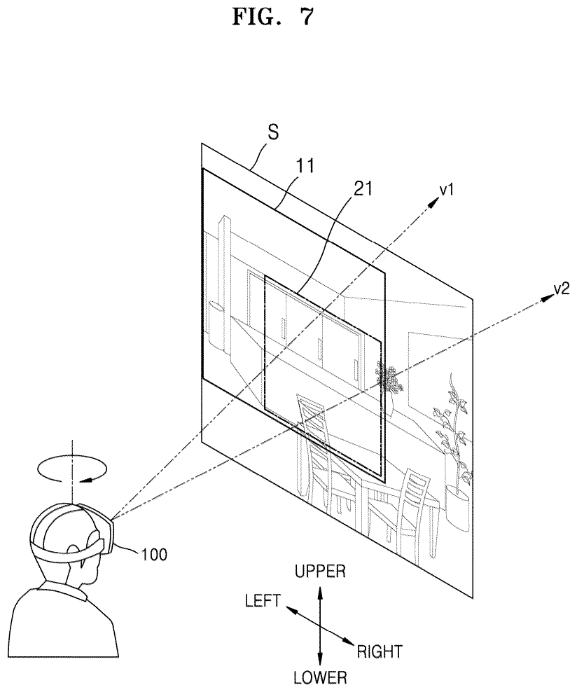

FIG. 7 is a diagram for describing an operation, performed by an electronic device, of predicting a line-of-sight prediction direction of a user's view, according to an embodiment of the present disclosure.

For convenience of explanation, the same aspects as described with reference to FIGS. 1 to 6 are briefly described or are not described.

Referring to FIG. 7, according to an embodiment, the electronic device 100 may obtain a base image 11 with respect to a first direction v1. As illustrated, the base image 11 may indicate an image with respect to a base region in a space S surrounding a user, the base region being photographed by using a wide-angle view. When the user views the first direction v1 after wearing the electronic device 100, the electronic device 100 may obtain the base image 11 with respect to the base region encompassing the first direction v1.

According to an embodiment, the electronic device 100 may obtain motion information by using the motion sensor. The motion information may include information about at least one of acceleration and angular velocity of the electronic device 100. However, the motion information may further include information about velocity or displacement calculated through acceleration.

According to an embodiment, the electronic device 100 may obtain the base image 11 and the motion information, corresponding to a time point at which the user views the first direction v1. The electronic device 100 may obtain, based on the base image 11 and the motion information, information about a motion of the user in the space surrounding the user. The motion information may correspond to the time point at which the user views the first direction v1.

The electronic device 100 may predict a line-of-sight prediction direction of a user's view, based on the motion information. The electronic device 100 may predict a second direction v2 as the line-of-sight prediction direction, based on the motion information.

For example, the electronic device 100 may obtain information about a movement speed of the user, based on the motion information. When the movement speed of the user is constant, the electronic device 100 may predict a position and a line-of-sight direction of the user after a predetermined time period, based on the constant movement speed.

As another example, the electronic device 100 may obtain information about a movement of a line-of-sight of the user, based on the motion information. For example, the electronic device 100 may obtain information about a rotation speed of the head of the user. When the rotation speed of the head of the user is constant, the electronic device 100 may predict the line-of-sight direction of the user after a predetermined time period, based on the constant rotation speed.

According to an embodiment, the electronic device 100 may set a prediction region 21 in the line-of-sight prediction direction. For example, the electronic device 100 may set the prediction region 21 in the second direction v2. The prediction region 21 may correspond to a region photographable through a second camera.

According to an embodiment, the electronic device 100 may obtain, based on the base image 11, segment light quantity information with respect to the prediction region 21. The electronic device 100 may determine, based on the segment light quantity information, an exposure value for capturing a line-of-sight image by using the second camera. The electronic device 100 may obtain, based on the determined exposure value, the line-of-sight image by photographing the prediction region 21 by using the second camera.

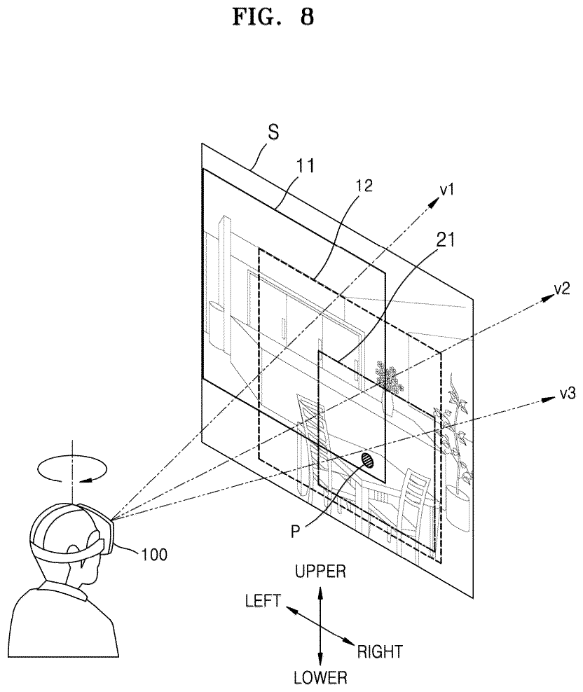

FIG. 8 is a diagram for describing an operation, performed by an electronic device, of predicting a line-of-sight prediction direction of a user's view, according to an embodiment of the present disclosure.

For convenience of explanation, the same aspects as described with reference to FIG. 7 are briefly described or are not described.

Referring to FIG. 8, according to an embodiment, the electronic device 100 may obtain a first base image 11. The base image may include an image sequence sequentially obtained during a predetermined time period. As illustrated, the base image may include the first base image 11 and a second base image 12 sequentially obtained. The first base image 11 may correspond to an image with respect to a first direction v1, and the second base image 12 may correspond to an image with respect to a second direction v2.

The first base image 11 and the second base image 12 captured with respect to the space S surrounding the user are illustrated to be sufficiently apart from each other, for convenience of explanation. However, a temporal space and a spatial space between the first base image 11 and the second base image 12 do not limit the technical concept of the present disclosure.

The electronic device 100 may obtain the base image and motion information corresponding to a direction of a user's view at every time point. The electronic device 100 may obtain, based on the base image and the motion information obtained at every time point, information about a motion of the user.

For example, the electronic device 100 may obtain the first base image 11 at a time point at which a line-of-sight direction of the user corresponds to the first direction v1 and may simultaneously obtain first motion information. The electronic device 100 may obtain, based on the first base image 11 and the first motion information, information about the motion of the user in the space surrounding the user. The first motion information may be obtained at the time point at which the user views the first direction v1.

As another example, the electronic device 100 may obtain the second base image 12 at a time point at which the line-of-sight direction of the user corresponds to the second direction v2 and may simultaneously obtain second motion information. The electronic device 100 may obtain, based on the second base image 12 and the second motion information, information about the motion of the user in the space surrounding the user. The second motion information may be obtained at the time point at which the user views the second direction v2.

According to an embodiment, the electronic device may obtain the motion information by determining the relative motion of the user by using a feature point included in the base image. For example, the base image may include an image sequence sequentially captured during a predetermined time period. As illustrated, the base image may include the first base image 11 and a second base image 12 sequentially captured. The electronic device may determine that a position of the user is shifted toward the right side, when the feature point included in the base image is shifted toward the left side. As another example, the electronic device may determine that a direction of the user is rotated, when the feature point included in the base image is shifted toward the left side.

Referring to FIG. 8, according to an embodiment, a feature point P may be located on an upper surface of a table. The position of the feature point P, the number of feature points P, the shape of the feature point P, etc. do not limit the technical scope of the present disclosure. The feature point P may be located at an edge of a lower right end in the first base image 11. The feature point P may be located at a position shifted, from the lower right edge, in a direction toward an upper left end, in the second base image 12. Thus, the electronic device 100 may identify that the feature point P may be shifted in the direction toward the upper left end during a time interval from the first base image 11 to the second base image 12. The electronic device 100 may determine that the line-of-sight direction of the user may be shifted in a direction toward the lower right end, when the feature point is shifted in the direction toward the upper left end. For example, the electronic device 100 may determine that the line-of-sight direction of the user may be shifted in the direction toward the lower right end, as the user sits after moving in a right direction. As another example, the electronic device 100 may determine that the line-of-sight direction of the user may be shifted in the direction toward the lower right end, as the head of the user is rotated in the direction toward the lower right end.

The electronic device 100 may predict the line-of-sight prediction direction of the user's view, based on the first motion information and the second motion information. The electronic device 100 may predict a third direction v3 as the line-of-sight prediction direction, based on the first motion information and the second motion information.

According to an embodiment, the electronic device 100 may set the prediction region 21 in the line-of-sight prediction direction. For example, the electronic device 100 may set the prediction region 21 in the third direction v3. The prediction region 21 may correspond to a region photographable through the second camera.

According to an embodiment, the electronic device 100 may obtain, based on the first and second base images 11 and 12, segment light quantity information with respect to the prediction region 21. The electronic device 100 may determine, based on the segment light quantity information, an exposure value for capturing the line-of-sight image by using the second camera. The electronic device 100 may obtain, based on the determined exposure value, the line-of-sight image by photographing the prediction region 21 by using the second camera.

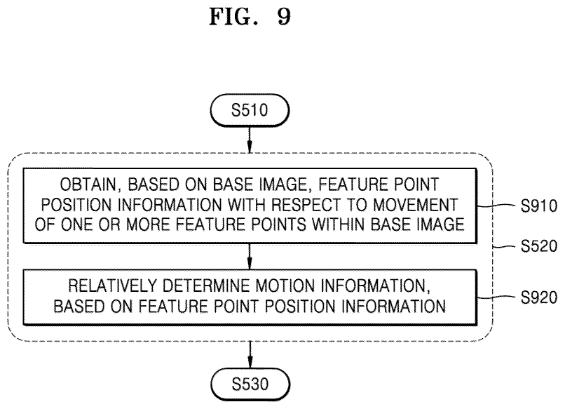

FIG. 9 is a flowchart of an operating method, performed by an electronic device, of predicting a line-of-sight prediction direction of a user's view by using a position of a feature point, according to an embodiment of the present disclosure.

The same aspects as described with reference to FIG. 5 are not described.

Referring to FIG. 9, operation S520 described with reference to FIG. 5 may include operations S910 and S920.

In operation S910, the electronic device may obtain, based on a base image, feature point position information with respect to a movement of one or more feature points in the base image.

According to an embodiment, the electronic device may obtain, as the feature point, a position of a certain halted object, a predetermined part, a predetermined region, etc., included in the base image. The base image may include an image sequence sequentially obtained during a predetermined time period. The electronic device may obtain the feature point position information with respect to the movement of the feature point within the base image sequentially captured.

For example, the electronic device may obtain, based on the base image, the feature point position information with respect to the movement of the feature point toward a left side. As another example, the electronic device may obtain, based on the base image, the feature point position information with respect to the movement of the feature point toward a right side.

In operation S920, the electronic device may determine motion information, based on the feature point position information. For example, the electronic device may determine the motion information based on a relative motion indicated by the feature point position information (e.g., a relative motion of the electronic device 100 with respect to the one or more feature points, or a relative motion of the one or more feature points with respect to the electronic device 100).

For example, the electronic device may determine that a position of a user is shifted toward the right side, as the feature point included in the base image is shifted toward the left side. As another example, the electronic device may determine that a direction of the user is rotated, as the feature point included in the base image is shifted toward the left side.

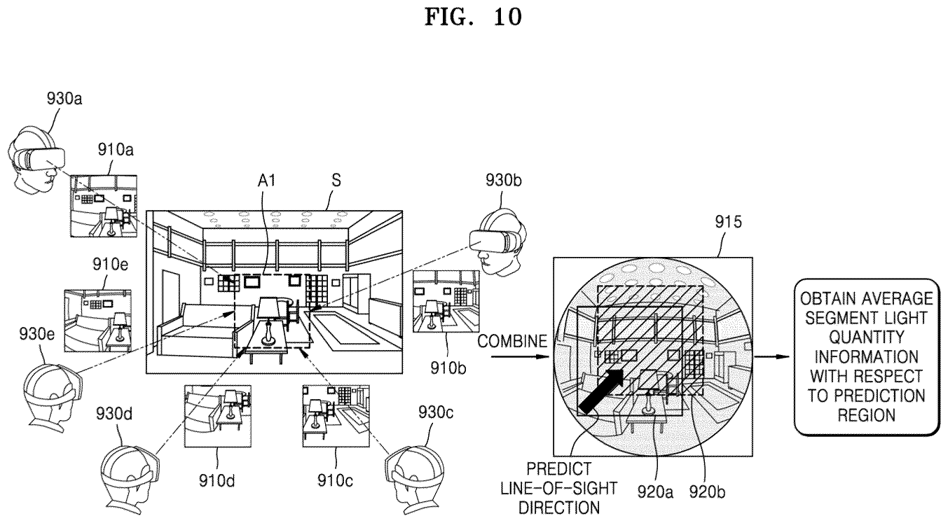

FIG. 10 is a diagram for describing a method, performed by an electronic device, of obtaining light quantity information with respect to a predicted direction, according to an embodiment of the present disclosure.

Referring to FIG. 10, the electronic device may calculate an average of the light quantity information, based on a plurality of base images commonly including a prediction region. The electronic device may determine, based on the average of the light quantity information, an exposure value for photographing the prediction region by using a second camera.

According to an embodiment, the electronic device may obtain a base image by using a first camera. The base image may include a plurality of images including a certain common region A1. For example, the base image may include first to fifth base images 910a to 910e commonly including the common region A1.

Each of the first to fifth base images 910a to 910e may be obtained by photographing, from a different direction, the common region A1 in a space S surrounding the user. For example, the third base image 910c may be captured with a view of a user 930c in a certain position toward the common region A1, and the fourth base image 910d may be captured with a view of a user 930d in a position a step apart in a left direction from the certain position, toward the common region A1. For example, the first to fifth base images 910a to 910e may be captured with views of users 930a to 930e in various positions toward the common region A1.

According to an embodiment, the electronic device may extract, from the light quantity information, a plurality of pieces of segment light quantity information with respect to the common region A1, based on the base images commonly including the common region A1. For example, the electronic device may extract, from the light quantity information, first segment light quantity information with respect to the common region A1, based on the first base image 910a including the common region A1. Similarly, the electronic device may extract, from the light quantity information, second segment light quantity information with respect to the common region A1, based on the second base image 910b including the common region A1. Methods of extracting third to fifth segment light quantity information may be the same or similar to the description above, and therefore redundant or duplicative description thereof may be omitted.

According to an embodiment, the electronic device may obtain average segment light quantity information with respect to the common region A1, based on the plurality of pieces of segment light quantity information with respect to the common region A1. For example, the electronic device may obtain the average segment light quantity information with respect to the common region A1, based on the first segment light quantity information and the second segment light quantity information. For convenience of explanation, the case where the average segment light quantity information may be obtained based on two pieces of segment light quantity information, is described as an example. However, the number of pieces of segment light quantity information used to obtain the average segment light quantity information does not limit the technical concept of the present disclosure.

According to an embodiment, the common region A1 may correspond to a prediction region 920b. For example, the electronic device may obtain the first to fifth base images 910a to 910e commonly including the prediction region and may use a plurality of pieces of segment light quantity information with respect to the prediction region in order to determine the exposure value of the second camera.

According to an embodiment, the common region A1 may indicate the prediction region 920b determined as being positioned in the line-of-sight prediction direction, after the electronic device predicts the line-of-sight prediction direction of the user's view, based on the motion information, as described with reference to FIG. 3. The electronic device may determine the prediction region 920b according to the line-of-sight prediction direction and may extract, from the light quantity information, the plurality of pieces of segment light quantity information with respect to the prediction region, based on the base images each commonly including the prediction region 920b. The electronic device may obtain average segment light quantity information, based on the plurality of pieces of segment light quantity information with respect to the prediction region 920b.

According to an embodiment, the electronic device may determine, based on the average segment light quantity information, the exposure value for photographing a space by using the second camera. The electronic device may determine, based on the average segment light quantity information, the exposure value for capturing a line-of-sight image with respect to the prediction region 920b by using the second camera. According to an embodiment, the electronic may obtain, based on the determined exposure value, the line-of-sight image with respect to the prediction region 920b by using the second camera.

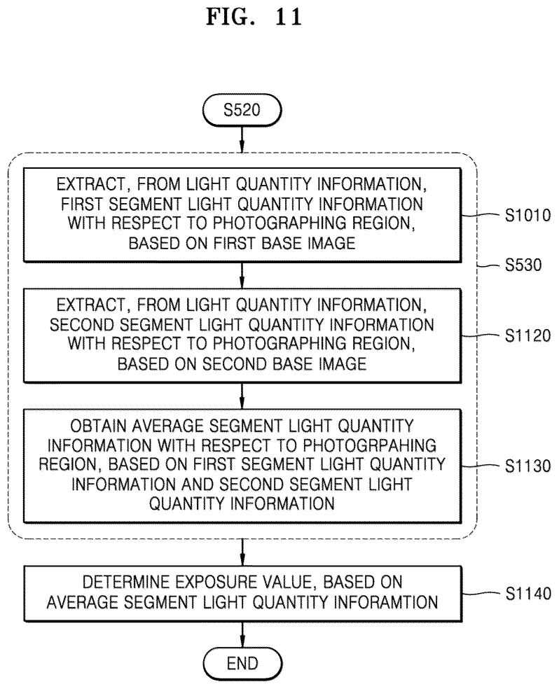

FIG. 11 is a flowchart of an operating method, performed by an electronic device, of obtaining light quantity information with respect to a predicted direction, according to an embodiment of the present disclosure.

For convenience of explanation, the same aspects as described with reference to FIG. 5 are briefly described or are not described.

Referring to FIG. 11, operation S530 described with reference to FIG. 5 may include operations S1110, S1120, and S1130.

According to an embodiment, a base image may include a plurality of images including a prediction region. For example, the base image may include a first base image and a second base image commonly including the prediction region. Each of the first base image and the second base image may be an image of a view toward the same prediction region from a different position.

When the prediction region is likewise viewed from different directions, light quantity information in the base image may not be precisely the same. For example, when there is an object from which light is reflected in a diffused fashion, there may be a difference in the light quantity information depending on a time point, even if the base image is obtained based on the same region.

In operation S1110, the electronic device may obtain, from light quantity information, first segment light quantity information with respect to the prediction region, based on the first base image. In operation S1120, the electronic device may obtain, from the light quantity information, second segment light quantity information with respect to the prediction region, based on the second base image.

Each of the first segment light quantity information and the second segment light quantity information may include the light quantity information with respect to the prediction region. However, the first segment light quantity information and the second segment light quantity information may be the pieces of information when the prediction region is viewed at different time points, and thus, may include different light quantity information even though the first segment light quantity information and the second segment light quantity information are the information with respect to the same prediction region.

In operation S1130, the electronic device may obtain average segment light quantity information with respect to the prediction region, based on the first segment light quantity information and the second segment light quantity information. The average segment light quantity information may denote an average of a plurality of pieces of segment light quantity information measured with respect to the prediction region. Accordingly, the electronic device according to an embodiment of the present disclosure may reduce an error due to wrongly measured information when the light quantity information with respect to the prediction region is obtained.

For convenience of explanation, the case where the average segment light quantity information may be obtained based on two pieces of segment light quantity information, is described as an example. However, the number of pieces of segment light quantity information used to obtain the average segment light quantity information does not limit the technical concept of the present disclosure.

In operation S1140, the electronic device may determine, based on the average segment light quantity information, an exposure value for capturing a line-of-sight image with respect to a line-of-sight prediction direction by using a second camera. The description about operation S1140 may be the same as the description with reference to operation S540 of FIG. 5. In operation S1140, the electronic device may determine, by using the average segment light quantity information, the exposure value for capturing the line-of-sight image with respect to the line-of-sight prediction direction by using the second camera.

According to an embodiment, the electronic may obtain, based on the determined exposure value, the line-of-sight image by using the second camera.

FIG. 12 is a diagram for describing a method, performed by an electronic device, of determining an exposure value, according to an embodiment of the present disclosure.

Referring to FIG. 12, according to an embodiment, the electronic device may store a light quantity matching list 1100 in the memory 160 (e.g., the memory 160 illustrated in FIG. 2). The light quantity matching list 1100 may include a table in which a light quantity measured by using the first camera 110 and a light quantity measured by using the second camera 120 are matched with respect to the same brightness.

For example, with a user moving after wearing the electronic device 100 and photographing a space surrounding the user by using the first camera 110 and the second camera 120, the light quantity matching list 1100 may be obtained. The electronic device 100 may store the light quantity matching list 1100 in the memory and obtain the stored light quantity matching list from the memory according to necessity.

The light quantity matching list 1100 may include light intensity measurement information based on the first camera and light intensity measurement information based on the second camera according to a certain brightness. The light quantity matching list 1100 may include an appropriate exposure value of the second camera 120 according to predetermined light intensity measurement information based on the second camera. Thus, the electronic device 100 may obtain, based on the light quantity matching list 1100, the light intensity measurement information based on the first camera according to the certain brightness and may obtain the corresponding appropriate exposure value of the second camera 120 according to the obtained light intensity measurement information based on the first camera.

For example, the light quantity matching list 1100 may include light intensity measurement information R1 based on the first camera and light intensity measurement information S1 based on the second camera, according to a certain brightness B1. The light quantity matching list 1100 may include an appropriate exposure value E1 of the second camera according to the predetermined light intensity measurement information S1 based on the second camera. Thus, when the electronic device 100 obtains the light intensity measurement information R1 based on the first camera, based on the light quantity matching list 1100, the electronic device 100 may obtain the appropriate exposure value E1 of the second camera 120 corresponding to the obtained light intensity measurement information R1 based on the first camera.

As another example, the light quantity matching list 1100 may include light intensity measurement information R2 based on the first camera and light intensity measurement information S2 based on the second camera, according to a certain brightness B2. The light quantity matching list 1100 may include an appropriate exposure value E2 of the second camera according to the predetermined light intensity measurement information S2 based on the second camera. Thus, when the electronic device 100 obtains the light intensity measurement information R2 based on the first camera, based on the light quantity matching list 1100, the electronic device 100 may obtain the appropriate exposure value E2 of the second camera 120 corresponding to the obtained light intensity measurement information R2 based on the first camera.

The electronic device 100 according to an embodiment of the present disclosure may directly obtain an appropriate exposure value of the second camera 120 corresponding to the light intensity measurement information based on the first camera, when the electronic device 100 obtains the light intensity measurement information based on the first camera by using the light quantity matching list 1100.

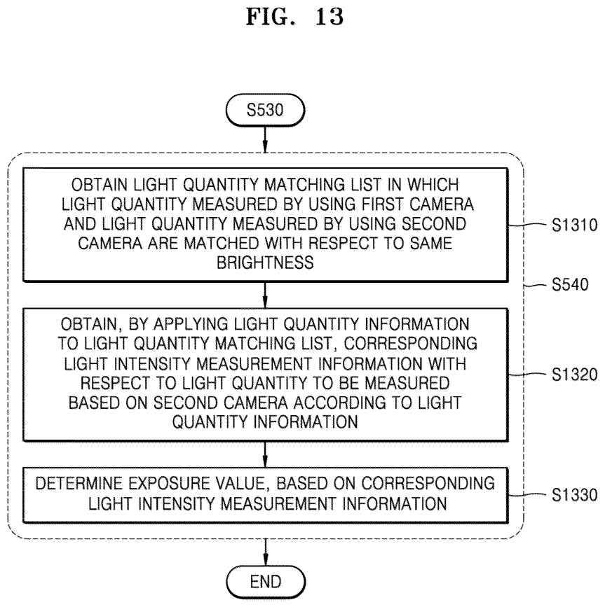

FIG. 13 is a flowchart of an operating method, performed by an electronic device, of determining an exposure value, according to an embodiment of the present disclosure.

For convenience of explanation, the same aspects as described with reference to FIG. 5 are not described.

Referring to FIG. 13, operation S540 described with reference to FIG. 5 may include operations S1310, S1320, and S1330.

In operation S1310, the electronic device may obtain a light quantity matching list. The light quantity matching list may include a table in which a light quantity measured by using a first camera for capturing a base image and a light quantity measured by using a second camera are matched with respect to the same brightness.

The light quantity matching list may include a table including each of the light intensity measurement information based on the first camera, the light intensity measurement information based on the second camera, and the appropriate exposure value of the second camera, with respect to the same brightness. The light quantity matching list may include a table in which each of the light intensity measurement information based on the first camera, the light intensity measurement information based on the second camera, and the appropriate exposure value of the second camera is matched according to a brightness in a certain range.

For example, the light quantity matching list may include a table in which the light intensity measurement information based on the first camera and light intensity measurement information based on the second camera are matched according to the same brightness. Also, the light quantity matching list may include a table in which the appropriate exposure value of the second camera is matched according to the light intensity measurement information based on the second camera. Accordingly, the light quantity matching list may include a table for obtaining the appropriate exposure value of the second camera corresponding to the light intensity measurement information based on the first camera, when the light intensity measurement information based on the first camera is obtained.

The electronic device may pre-obtain and store the light quantity matching list in the memory 160 (e.g., the memory 160 illustrated in FIG. 2). The electronic device may obtain the light quantity matching list stored in the memory 160 when necessary.

In operation S1320, the electronic device apply segment light quantity information to the light quantity matching list so as to obtain corresponding light intensity measurement information with respect to a light quantity to be measured based on the second camera according to the segment light quantity information.

The segment light quantity information may be obtained from the base image captured by the first camera, and thus, may correspond to the light intensity measurement information based on the first camera of the light quantity matching list.

For convenience, it is assumed that the light intensity measurement information R1 based on the first camera and the light intensity measurement information S1 based on the second camera are matched according to the light quantity matching list. The electronic device may apply, to the light quantity matching list, the segment light quantity information measured as the light intensity measurement information R1 based on the first camera. The electronic device may obtain, according to the segment light quantity information measured as the light intensity measurement information R1 based on the first camera, the light intensity measurement information S1 based on the second camera, as corresponding light intensity measurement information. As a result, when the electronic device obtains the segment light quantity information measured as the light intensity measurement information R1 based on the first camera, the electronic device may obtain the corresponding light intensity measurement information measured as the light intensity measurement information S1 based on the second camera.

In operation S1330, the electronic device may determine the exposure value based on the corresponding light intensity measurement information. The light quantity matching list may include the exposure value based on the light intensity measurement information based on the second camera, and the electronic device may apply the corresponding light intensity measurement information to the light quantity matching list to obtain the corresponding exposure value.

For convenience, it is assumed that the light intensity measurement information S1 based on the second camera and the appropriate exposure value E1 of the second camera are matched according to the light quantity matching list. The electronic device may apply, to the light quantity matching list, the corresponding light intensity measurement information measured as the light intensity measurement information S1 based on the second camera. The electronic device may obtain the appropriate exposure value E1 of the second camera, according to the corresponding light intensity measurement information measured as the light intensity measurement information S1 based on the second camera. As a result, when the electronic device obtains the corresponding light intensity measurement information measured as the light intensity measurement information S1 based on the second camera, the electronic device may determine the appropriate exposure value of the second camera as the appropriate exposure value E1 of the second camera.

Operations S1320 and S1330 are separately explained only for convenience of explanation, and the technical concept of the present disclosure is not limited thereto. The light quantity matching list may include a table in which all of the light intensity measurement information based on the first camera, the light intensity measurement information based on the second camera, and the appropriate exposure value of the second camera are matched according to a certain brightness, and thus, the electronic device may instantly obtain the appropriate exposure value of the second camera by applying the segment light quantity information to the light quantity matching list. For example, operation S1320 and operation S1330 may be performed as a single operation.

An electronic device according to an embodiment of the present disclosure may include a first camera, a second camera, a motion sensor, a memory, and at least one processor. The first camera may be configured to capture a base image with respect to a space corresponding to the electronic device. According to embodiments, the space corresponding to the electronic device may be a at least one of a space in which the electronic device is located, and a space including a region which is to be included in an image captured by a camera included in the electronic device. In some embodiments, the space corresponding to the electronic device may be a space around or surrounding the electronic device, and may therefore be referred to as a surrounding space, but embodiments are not limited thereto. The second camera may be configured to capture a line-of-sight image corresponding to a line-of-sight direction. The memory may store at least one instruction. The least one processor may be configured to execute the at least one instruction. The at least one processor may be configured to execute the at least one instruction to obtain information about a light quantity of the surrounding space, based on the base image. The at least one processor may be configured to execute the at least one instruction to determine, based on motion information obtained by the motion sensor and the light quantity information, an exposure value for capturing the line-of-sight image.

According to an embodiment, an angle of view of the first camera may be greater than an angle of view of the second camera.

According to an embodiment, a region included in the base image may include a region included in the line-of-sight image.

According to an embodiment, the at least one processor may further be configured to execute the at least one instruction to obtain, based on the base image, feature point position information with respect to a movement of one or more feature points within the base image. The at least one processor may further be configured to execute the at least one instruction to determine the motion information by further using the feature point position information. For example, the relative motion may be determined based on a relative motion indicated by the feature point position information (e.g., a relative motion of the electronic device 100 with respect to the one or more feature points, or a relative motion of the one or more feature points with respect to the electronic device 100).

According to an embodiment, the base image may include an image sequence sequentially obtained during a predetermined time period. The motion information may include at least one of position, velocity, acceleration, and angular velocity.

According to an embodiment, the base image may be captured before a first time point. The at least one processor may further be configured to execute the at least one instruction to determine, based on the motion information obtained by the motion sensor before the first time point and the light quantity information, the exposure value for capturing the line-of-sight image at a second time point, which is after the first time point.

According to an embodiment, the at least one processor may further be configured to execute the at least one instruction to predict, based on the motion information, a photographing region of the second camera. The at least one processor may further be configured to execute the at least one instruction to obtain segment light quantity information with respect to the photographing region, from the light quantity information. The at least one processor may further be configured to execute the at least one instruction to determine, based on the segment light quantity information, the exposure value for capturing the line-of-sight image.

According to an embodiment, the base image may include a first base image and a second base image commonly including the photographing region. The at least one processor may further be configured to execute the at least one instruction to obtain, from the light quantity information, first segment light quantity information with respect to the photographing region, based on the first base image. The at least one processor may further be configured to execute the at least one instruction to obtain, from the light quantity information, second segment light quantity information with respect to the photographing region, based on the second base image. The at least one processor may further be configured to execute the at least one instruction to obtain average segment light quantity information with respect to the photographing region, based on the first segment light quantity information and the second segment light quantity information. The at least one processor may further be configured to execute the at least one instruction to determine the exposure value, based on the average segment light quantity information.

According to an embodiment, the at least one processor may further be configured to execute the at least one instruction to obtain a base map with respect to the surrounding space, the base map being pre-obtained by combining the base image (e.g., by combining a plurality of sequentially-obtained images included in the base image). The at least one processor may further be configured to execute the at least one instruction to obtain the light quantity information from the base map.

According to an embodiment, the at least one processor may further be configured to execute the at least one instruction to obtain a light quantity matching list in which a light quantity measured by using the first camera and a light quantity measured by using the second camera are matched with respect to a same brightness. The at least one processor may further be configured to execute the at least one instruction to obtain, by applying the light quantity information to the light quantity matching list, corresponding light intensity measurement information with respect to a light quantity to be measured based on the second camera according to the light quantity information. The at least one processor may further be configured to execute the at least one instruction to determine the exposure value, based on the corresponding light intensity measurement information.

A method according to an embodiment of the present disclosure may include obtaining information with respect to a light quantity of a surrounding space, based on a base image with respect to the surrounding space. The method may include determining, based on motion information obtained by a motion sensor and light quantity information, an exposure value for capturing a line-of-sight image corresponding to a line-of-sight direction.

According to an embodiment, a region included in the base image may include a region included in the line-of-sight image.

According to an embodiment, the obtaining of the motion information may include obtaining, based on the base image, feature point position information with respect to a movement of one or more feature points within the base image. The obtaining of the motion information may include determining the motion information by further using the feature point position information. For example, the motion information may be obtained based on a relative motion indicated by the feature point position information (e.g., a relative motion of the electronic device 100 with respect to the one or more feature points, or a relative motion of the one or more feature points with respect to the electronic device 100).

According to an embodiment, the base image may include an image sequence sequentially obtained during a predetermined time period The motion information may include at least one of position, velocity, acceleration, and angular velocity.

According to an embodiment, the base image may be captured before a first time point. The determining of the exposure value may include determining, based on the motion information obtained by the motion sensor before the first time point and the light quantity information, the exposure value for capturing the line-of-sight image at a second time point, which is after the first time point.

According to an embodiment, the determining of the exposure value may further include predicting, based on the motion information, a photographing region of the second camera. The determining of the exposure value may further include obtaining segment light quantity information with respect to the photographing region, from the light quantity information. The determining of the exposure value may further include determining, based on the segment light quantity information, the exposure value for capturing the line-of-sight image.

According to an embodiment, the base image may include a first base image and a second base image commonly including the photographing region. The obtaining of the segment light quantity information may include obtaining, from the light quantity information, first segment light quantity information with respect to the photographing region, based on the first base image. The obtaining of the segment light quantity information may include obtaining, from the light quantity information, second segment light quantity information with respect to the photographing region, based on the second base image. The obtaining of the segment light quantity information may include obtaining average segment light quantity information with respect to the photographing region, based on the first segment light quantity information and the second segment light quantity information. The determining of the exposure value may further include determining the exposure value, based on the average segment light quantity information.

According to an embodiment, the obtaining of the light quantity information may include obtaining a base map with respect to the surrounding space, the base map being pre-obtained by combining the base image (e.g., by combining a plurality of sequentially-obtained images included in the base image). The obtaining of the light quantity information may include obtaining the light quantity information from the base map.

According to an embodiment, the determining of the exposure value may further include obtaining a light quantity matching list in which a light quantity measured by using a first camera configured to capture the base image and a light quantity measured by using the second camera are matched with respect to a same brightness. The determining of the exposure value may further include obtaining, by applying the light quantity information to the light quantity matching list, corresponding light intensity measurement information with respect to a light quantity to be measured based on the second camera according to the light quantity information. The determining of the exposure value may further include determining the exposure value, based on the corresponding light intensity measurement information.

In order to solve the technical problem described above, according to another embodiment of the present disclosure, there is provided a computer-readable recording medium having recorded thereon a program to be executable on a computer.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment, the method according to various embodiments according to the present disclosure may be provided as an inclusion of a computer program product. The computer program product may be transacted between a seller and a purchaser as a product. The computer program product may be distributed in the form of a machine-readable storage medium (e.g., a compact disc read only memory (CD-ROM)) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

What is claimed is:

1. An electronic device comprising:
a first camera configured to capture a base image with respect to a space corresponding to the electronic device;
a second camera configured to capture a line-of-sight image corresponding to a line-of-sight direction;
a motion sensor;
at least one processor; and
a memory storing at least one instruction which, when executed by the at least one processor, causes the electronic device to:
obtain light quantity information about a light quantity associated with the space, based on the base image; and
determine, based on motion information obtained by the motion sensor and the light quantity information, an exposure value for capturing the line-of-sight image.

2. The electronic device of claim 1, wherein an angle of view of the first camera is greater than an angle of view of the second camera.

3. The electronic device of claim 1, wherein a region included in the base image comprises a region included in the line-of-sight image.

4. The electronic device of claim 1, wherein the at least one instruction, when executed by the at least one processor, further causes the electronic device to obtain, based on the base image, feature point position information with respect to a movement of one or more feature points within the base image, and
wherein the motion information is further determined based on a relative motion indicated by the feature point position information.

5. The electronic device of claim 1, wherein the base image comprises an image sequence sequentially obtained during a predetermined time period, and
wherein the motion information comprises at least one of a position, a velocity, an acceleration, and an angular velocity.

6. The electronic device of claim 1, wherein the base image is captured before a first time point, and
wherein the at least one instruction, when executed by the at least one processor, further causes the electronic device to determine the exposure value for capturing the line-of-sight image at a second time point based on the motion information obtained by the motion sensor before the first time point and the light quantity information,
wherein the second time point is after the first time point.

7. The electronic device of claim 1, wherein the at least one instruction, when executed by the at least one processor, further causes the electronic device to:
predict, based on the motion information, a photographing region corresponding to the second camera;
obtain segment light quantity information with respect to the photographing region based on the light quantity information; and
based on the segment light quantity information, determine the exposure value for capturing the line-of-sight image.

8. The electronic device of claim 7, wherein the base image comprises a first base image and a second base image,
wherein each of the first base image and the second base image include the photographing region, and
wherein the at least one instruction, when executed by the at least one processor, further causes the electronic device to:
obtain, based on the light quantity information, first segment light quantity information with respect to the photographing region, based on the first base image;
obtain, based on the light quantity information, second segment light quantity information with respect to the photographing region, based on the second base image;
obtain average segment light quantity information with respect to the photographing region based on the first segment light quantity information and the second segment light quantity information; and
determine the exposure value based on the average segment light quantity information.

9. The electronic device of claim 1, wherein the at least one instruction, when executed by the at least one processor, further causes the electronic device to:
obtain a base map with respect to the space, wherein the base map is pre-obtained by combining an image sequence included in the base image; and
obtain the light quantity information based on the base map.

10. The electronic device of claim 1, wherein the at least one instruction, when executed by the at least one processor, further causes the electronic device to:
obtain a light quantity matching list in which a first light quantity measured using the first camera and a second light quantity measured using the second camera are matched with respect to a same brightness;
apply the light quantity information to the light quantity matching list to obtain corresponding light intensity measurement information with respect to a light quantity to be measured based on the second camera according to the light quantity information; and
determine the exposure value based on the corresponding light intensity measurement information.

11. A method executed by at least one processor included in an electronic device, the method comprising:
obtaining light quantity information about a light quantity associated with a space corresponding to the electronic device, based on a base image with respect to the space; and
based on the light quantity information and motion information obtained by a motion sensor included in the electronic device, determining an exposure value for capturing a line-of-sight image corresponding to a line-of-sight direction.

12. The method of claim 11, wherein the obtaining of the motion information comprises:
obtaining, based on the base image, feature point position information with respect to a movement of one or more feature points within the base image; and
determining the motion information based on a relative motion indicated by the feature point position information.

13. The method of claim 11, wherein the determining of the exposure value comprises:
predicting a photographing region of a second camera based on the motion information;
obtaining segment light quantity information with respect to the photographing region based on the light quantity information; and
determining the exposure value for capturing the line-of-sight image based on the segment light quantity information.

14. The method of claim 13, wherein the determining of the exposure value further comprises:
obtaining a light quantity matching list in which a first light quantity measured using a first camera configured to capture the base image and a second light quantity measured by using the second camera are matched with respect to a same brightness;
applying the light quantity information to the light quantity matching list to obtain corresponding light intensity measurement information with respect to a light quantity to be measured based on the second camera according to the light quantity information; and
determining the exposure value based on the corresponding light intensity measurement information.

15. A computer-readable recording medium having recorded thereon at least one program which, when executed by at least one processor of an electronic device, causes the electronic device to:
obtain light quantity information about a light quantity associated with a space corresponding to the electronic device, based on a base image with respect to the space; and
based on the light quantity information and motion information obtained by a motion sensor included in the electronic device, determine an exposure value for capturing a line-of-sight image corresponding to a line-of-sight direction.
